(19) United States
(12) Patent Application Publication
(10) Pub. No.: US 2011/0214405 A1
(43) Pub. Date: Sep. 8, 2011

(54) NACELLE AIR INTAKE STRUCTURE

(75) Inventors: Jean-Philippe Joret, Beuzeville (FR); Guy Bernard Vauchel, Harfleur (FR)

(73) Assignee: AIRCELLE, Gonfreville L'Orcher (FR)

(21) Appl. No.: 13/129,226

(22) PCT Filed: Oct. 23, 2009
(86) PCT No.: PCT/FR09/01245

§ 371 Date: May 13, 2011

(30) Foreign Application Priority Data
Nov. 13, 2008 (FR) 08 06315

(51) Int. Cl. F16P 1/00

(52) U.S. Cl. 60/39.11

(57) ABSTRACT

The invention relates to a nacelle comprising an air intake structure (1) able to channel a flow of air towards a fan of the turbojet engine, said structure (1) comprising at least one inner panel (11) and one outer panel (10), the outer panel (10) being able to be moved by guide means (30) so as to open up the air intake structure (1), characterized in that it further comprises means (40, 60) for protecting the inner panel (11) against fire, said means being able to be moved in whole or in part when the air intake structure (1) is opened.

### TECHNICAL FIELD

The invention relates to a turbojet nacelle.

### BACKGROUND

In general, an aircraft nacelle has a structure comprising an air intake structure, a middle structure, and a downstream section. The term “downstream” here refers to the direction corresponding to the direction of the cold air flow penetrating the turbojet engine. The term “upstream” designates the opposite direction.

The air intake structure comprises at least one outer panel, at least one inner panel, and an air intake lip having an inner wall intended to be in contact with the stream of air penetrating the turbojet engine.

The middle structure is intended to surround a fan of the turbojet engine. Said structure is fastened to the air intake structure fixedly by the inner panel(s) and movably by the outer panels so as to ensure aerodynamic continuity.

Thus, the nacelle comprises an upstream structure including an air intake lip and the outer panel(s), said structure being able to move relative to a fixed structure including the inner panel(s).

This type of mobile upstream structure makes it possible to access the equipment housed inside the nacelle to perform maintenance on said equipment.

Thus, under flight conditions, the air intake structure is in the closed position, i.e. the mobile upstream structure is fixed on the inner panel(s) and on the middle structure.

In the open position of the air intake structure, i.e. when the air intake lip and the outer panel(s) are withdrawn into the upstream position, the operator has access to the inside of the nacelle. He can therefore perform the necessary maintenance operations.

To perform maintenance operations on equipment housed inside the nacelle, the mobile upstream structure is slid using guide means.

Generally, such guide means are in the form of a system of rails.

Moreover, the inner panel(s) can be provided with at least one acoustic shroud, in particular a honeycomb structure, so as to absorb the noise annoyances resulting from the operation of the turbojet engine.

In the event the acoustic shroud is not a fire-compatible structure, a fire protection sealed partition must be placed downstream of its structure.

However, to ensure that the air intake structure is pulled far enough back during opening thereof to reach the pieces inside the nacelle, the structure of the guide means must overhang, in the upstream direction, the acoustic shroud, which makes it impossible to arrange such constant fire protection on the downstream periphery of said shroud.

### BRIEF SUMMARY

One aim of the present invention is to provide a nacelle comprising an air intake structure not having the aforementioned drawbacks.

Another aim of the present invention is to propose a nacelle comprising an air intake structure provided with a fire resistant structure to protect the inner panel(s) regardless of the dimensions and shape of the guide means of the outer panel(s) of the air intake structure.

To that end, the invention proposes a nacelle comprising an air intake structure capable of channeling a stream of air towards a turbojet engine fan, said structure comprising at least one inner panel and one outer panel, the outer panel being able to be moved by guide means so as to open the air intake structure, characterized in that it also comprises means for protecting the inner panel from fire, said means being able to be moved in whole or in part when the air intake structure is opened.

Owing to the present invention, the guide means of the outer panel are no longer an obstacle to the arrangement of a structure for protecting the inner panels of the air intake structure from fire.

According to other features of the invention, the air intake structure according to the invention includes one or several of the following optional features, considered independently or according to all possible combinations:
the fire protection means comprise at least one partition configured so as to separate the inner panel from the guide means of the outer panel when the air intake structure is closed;
the partition extends towards the upstream direction of the inner panel;
the partition is attached, at one of its ends, to an upstream part of the outer panel and, at the opposite end, to the downstream end of the inner panel;
the partition is capable of being removably secured on a rear fire protection partition structure 16;
the partition comprises centering means capable of being secured on corresponding centering elements formed on a fan casing;
the partition comprises two distinct parts, a fixed downstream part intended to be fastened on the inner panel and a mobile upstream part intended to be fastened on the outer panel and capable of being moved when the air intake structure is opened;
a sealing gasket is inserted between the two parts of the partition when the air intake structure is closed;
the partition is metallic.

### BRIEF DESCRIPTION OF THE DRAWINGS

Other features, aims and advantages of the present invention will appear upon reading the detailed description that follows, according to embodiments provided as non-limiting examples, and done in reference to the appended drawings, in which:

FIGS. 1 and 2 are partial longitudinal cross-sectional views of a first embodiment of a nacelle according to the present invention comprising an air intake structure in the closed position and in the completely open position, respectively;

FIG. 3 is a transverse cross-section of the nacelle of FIGS. 1 and 2;

FIGS. 4 and 5 are partial longitudinal cross-sectional views of a second embodiment of a nacelle according to the present invention comprising an air intake structure in the closed position and in the completely open position, respectively.

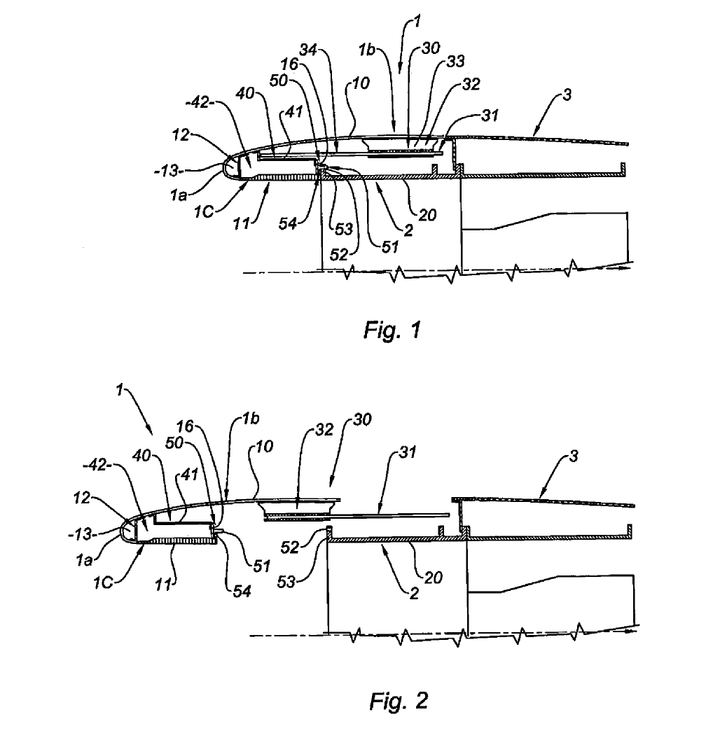

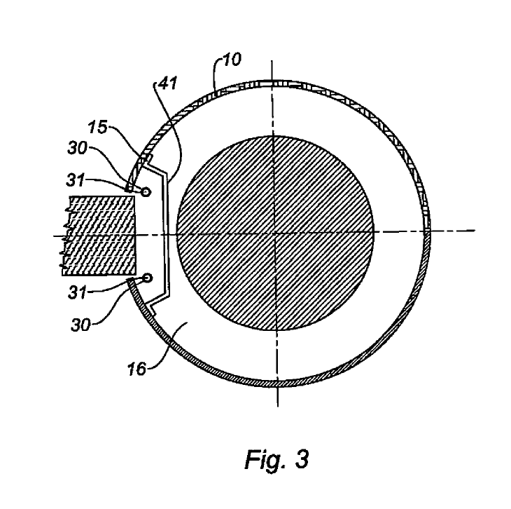

As illustrated in FIGS. 1 to 3, a nacelle has a structure comprising an air intake structure 1 upstream, a middle structure 3 downstream of a fan casing structure 2 surrounding an engine body and a downstream section (not shown) generally housing a thrust reverser system.

The air intake structure 1 is divided into three zones. The first zone furthest upstream is an air intake lip 1a adapted to allow optimal collection towards the turbojet engine of the air necessary to power the fan and the internal compressors of the turbojet engine. The second zone is a section 1b connected to one end of the air intake lip 1a comprising at least one outer panel 10. The third zone is a section 1c connected to the other end of the air intake lip 1a and including at least one inner panel 11 intended to suitably channel the air towards the vanes (not shown) of the fan.

The air intake structure 1 also includes a partition 12 separating the air intake lip 1a from the rest of said structure 1. This partition 12 thus makes it possible to delimit a sealed cavity 13 within which equipment, such as deicing equipment, for example of the pneumatic or electric type, is arranged to ensure the operation of the nacelle.

The middle structure 3 comprises an engine casing fastened, at one end, to the downstream end of the structure 2 of the fan casing 20 and, at the opposite end, to the downstream section.

The middle structure 3 is also attached at an upstream end to the air intake structure 1 via the structure 2 of the fan casing 20 so as to ensure aerodynamic continuity.

The inner panel 11 of the air intake structure 1 comprises an acoustic shroud intended to attenuate the sound annoyances due to the operation of the turbojet engine and the vibrations of the structure. This acoustic shroud is typically made up of a honeycomb structure or any other structure known by those skilled in the art making it possible to absorb the sound annoyances.

The air intake lip 1a is fastened to the outer panel 10 and the inner panel 11 so as to form a single disassemblable piece, called mobile upstream structure. To that end, the air intake lip 1a can be incorporated into the outer panel 10 and the inner panel 11.

Thus, the air intake structure 1 is removably fastened on a fixed structure including the casing 20 structure 2 and the middle structure 3.

FIG. 1 illustrates the air intake structure 1 in the closed position, the outer 10 and inner 11 panels ensuring the aerodynamic continuity of the outside of the nacelle while FIG. 2 corresponds to the air intake structure 1 in the completely open position thereby making it possible to access the equipment housed inside the nacelle for maintenance.

In order to allow the mobile upstream structure to withdraw upstream of the nacelle and thereby open the air intake structure 1 as illustrated in FIG. 2, the latter is typically provided with guide means 30 able to allow axial sliding of the outer panel 10 towards the upstream of the nacelle.

According to one embodiment, the guide means 30 comprise a system of rails 31 and mobile assembly means 32 for assembling the outer panel 10 on the system of rails 31.

The assembly means 32 as well as the system of rails 31 can have any form capable of allowing substantially rectilinear longitudinal movement of the assembly means 32 relative to the system of rails 31.

The embodiment shown in FIGS. 1 to 3 shows a non-limiting example of a system of rails 31 that can extend from the downstream end of the fan casing 2 structure 2 in the upstream direction beyond the interface between the inner panel 11 and the casing 20 over a large part of the length of the inner panel 11.

A guideway 33 fastened at one of its ends to the outer panel 10 is capable of sliding longitudinally on the rail 34 fastened on the fixed structure relative to the axis of the nacelle so as to drive the mobile upstream structure in translation.

Non-limiting examples of guide means 30 include crossheads on rails, a system of rolling skates capable of cooperating with a corresponding rail as well as a longitudinal axis capable of sliding through a corresponding opening.

According to the invention, the air intake structure 1 also comprises means 40 for protecting the inner panel 11 from fire capable of being moved with the mobile upstream structure when the outer panel 10 slides axially owing to the guide means 30 to ensure opening of the air intake structure 1.

The guide means 30 of the outer panel 10 and, as a result, of the mobile upstream structure are then no longer an obstacle to arranging a fire resistant structure intended to protect the inner panel(s) 11 of the air intake structure 1.

These fire protection means 40 comprise a partition 41 configured so as to separate the inner panel 11 from the guide means 30 of the outer panel 10 when the air intake structure 1 is in the closed position.

This partition 41 extends in the upstream direction of the air intake structure 1 beyond the interface between the inner panel 11 and the casing 20, opposite the usual partition 12 of the sealing lip 1a.

More precisely, this partition 41 is fastened at its upstream end to an upstream part of the outer panel 10 upstream of the upstream end of the guide means 30 and, more precisely, of the system of rails 31 via a fastening clip 15 fastened on the outer panel 10 or any other means known by those skilled in the art.

At its downstream end, it is fastened to the downstream end of the inner panel 11 upstream of the interface with the fixed structure via a fastening clip fastened on the inner panel 11 or any other means known by those skilled in the art.

More precisely, the fire protection partition 41 is fastened at its downstream end, using any known means, to an end of a rear fire protection partition 16 extending in a plane perpendicular to the longitudinal axis of the nacelle, this partition 16 being fastened at its opposite end to the inner panel 11.

One alternative embodiment can provide that the fire protection partition 41 and the rear fire protection partition 16 form a single piece.

In one embodiment, the fire protection partition 41 is metallic. However, other types of partition can be proposed.

Advantageously, owing to such a partition configuration 41 for fire protection, the inner panel 11 is isolated from the guide means 30 in a sealed cavity 42 outside the fire zone of the nacelle, this cavity in particular being delimited by the fire protection partition 41 and the usual partition 12 of the air intake lip 1a when the air intake structure 1 is in the closed position.

The fire protection partition 41 also comprises centering means 50 complementary to the fixed structure so as to precisely center said partition and, as a result, the mobile upstream structure to the fixed structure.

According to one embodiment, the partition 41 comprises a centering element 51 fastened to its downstream end and capable of centering itself on a corresponding element 52 fastened on a clip 53 at the upstream end of the casing 20, which makes it possible to ensure the aerodynamic continuity between the downstream end of the inner panel 11 and the upstream end of the casing 20 when the air intake structure 1 is in the closed position.

These centering elements are all elements known by those skilled in the art. To that end, examples include rigid centering means, such as centering lugs capable of cooperating with corresponding bores, and/or flexible ones to ensure structural continuity, such as an elastic tab. Examples also include roller centering systems, such as those described in application FR 08/03558, for example.

These centering elements 51, 52 make it possible to ensure the purest possible aerodynamic continuity.

A peripheral joint 54 indifferently arranged at the interface on either the clip of the casing 20 or the rear fire protection partition 16 ensures sealing between the cavity containing the system of rails 31 and the inside of the inner panel 11. Any joint known by those skilled in the art can be inserted between the rear fire partition 16 or the rear fastening clip of the fire protection partition 41 on the inner panel 11 and the casing 20.

One alternative embodiment of the preset invention provides for nacelles comprising several guide means 30 distributed around the acoustic shroud of the inner panel 11.

In this case, a fire protection partition 41 as previously described relative to FIGS. 1 to 3 may be arranged between each of the guide means 30 and the acoustic shroud of the inner panel 11.

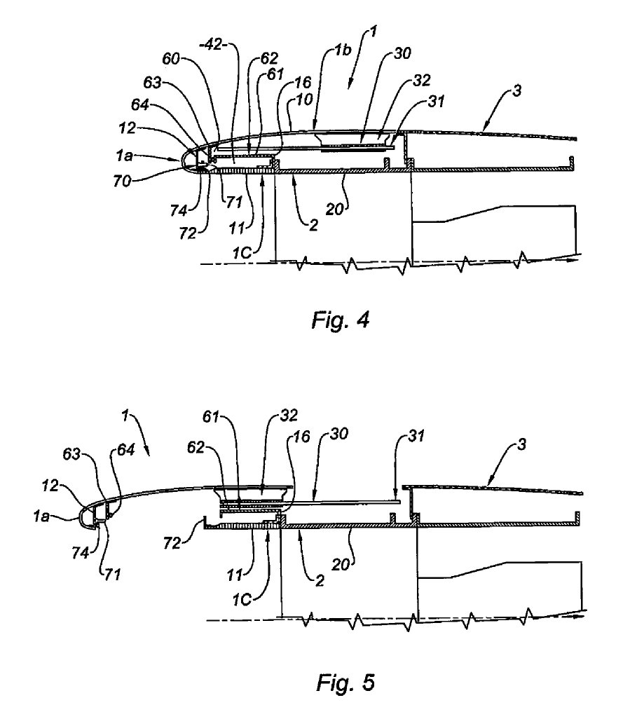

According to a second embodiment of the nacelle shown in FIGS. 4 and 5, the air intake structure 1 comprises means 60 for protecting the inner panel 11 from fire capable of being partially moved during opening thereof.

Indeed, in this embodiment, the inner panel 11 is fixed at its downstream end to an upstream end of the casing 20 forming, with the casing 20, the fixed structure of the nacelle. It is no longer part of the mobile upstream structure of the latter.

As a result, a partition 61 for protecting the inner panel 11 from fire similar to the partition as described in FIGS. 1 and 2 is used with the difference that it has two parts, i.e. a downstream part 62 fastened at its downstream end to the inner panel 11 and more precisely on the rear fire protection partition 16, thus belonging to the fixed structure, and an upstream part 63 fastened on an upstream part of the outer panel 10 thus belonging to the mobile upstream structure.

The upstream part 63 of the partition 61 is then capable of being moved when the outer panel 10 slides axially to open the air intake structure 1, as illustrated in FIG. 5.

Moreover, in this second embodiment, the centering means 50 between the downstream end of the fire protection partition 41 and the casing 20 as previously mentioned in reference to FIGS. 1 and 2 are eliminated.

The junction zone between the two upstream and downstream parts 62, 63 of the fire protection partition 61 is situated at the upstream end of the inner panel 11.

To ensure sealing between these two parts, in the closed position of the air intake structure 1, and, as a result, to make the cavity 42 sealed outside the fire zone in which the inner panel 11 is located, a joint 64 is inserted between the two parts 62, 63 of the fire protection partition 61. It is arranged on either one of the two parts 62, 63 of the partition 61. Of course, its composition is chosen to withstand fire.

Moreover, in order to removably fasten the mobile upstream structure to the fixed structure, the downstream end of the air intake lip 1a and the upstream end of the inner panel 11 are fastened together via centering means 70 similar to those described in reference to FIGS. 1 and 2.

This makes it possible to ensure the aerodynamic continuity between the mobile upstream structure and the fixed structure when the air intake structure 1 is in the closed position.

According to the embodiment illustrated in FIGS. 4 and 5, the usual partition 12 of the air intake lip 1a thus includes a centering element 71 fastened to its downstream end capable of centering itself on a corresponding element 72 fixed on a clip at the upstream end of the inner panel 11.

Moreover, a peripheral joint 64 indifferently arranged at the interface on either one of the clip of the inner panel 11 or the centering means 70 of the usual partition 12 of the air intake lip 1a ensures sealing between the cavity containing the guide means 30 and the inside of the inner panel 11.

Of course, the invention is not limited to the embodiments of this nacelle described above as examples, but on the contrary encompasses all possible alternatives.

1. A nacelle comprising an air intake structure capable of channeling a stream of air towards a turbojet engine fan, said structure comprising at least one inner panel and one outer panel, the outer panel being able to be moved by guide means so as to open the air intake structure, wherein it also comprises means for protecting the inner panel from fire, said means being able to be moved in whole or in part when the air intake structure is opened.

2. The nacelle according to claim 1, wherein the fire protection means comprise at least one partition configured so as to separate the inner panel from the guide means of the outer panel when the air intake structure is closed.

3. The nacelle according to claim 2, wherein the partition extends towards the upstream direction of the inner panel.

4. The nacelle according to claim 3, wherein the partition is attached, at one of its ends, to an upstream part of the outer panel and, at the opposite end, to the downstream end of the inner panel.

5. The nacelle according to claim 2, wherein the partition is capable of being removably secured on a rear fire protection partition structure.

6. The nacelle according to claim 5, wherein the partition comprises centering means capable of being secured on corresponding centering elements formed on a fan casing.

7. The nacelle according to claim 2, wherein the partition comprises two distinct parts, a fixed downstream part intended to be fastened on the inner panel and a mobile upstream part intended to be fastened on the outer panel and capable of being moved when the air intake structure is opened.

8. The nacelle according to claim 7, wherein a sealing gasket is inserted between the two parts of the partition when the air intake structure is closed.

9. The nacelle according to claim 2, wherein the partition is metallic.
